(19) United States
(12) Patent Application Publication
(10) Pub. No.: US 2026/0292691 A1
(43) Pub. Date: Sep. 24, 2026

(54) ENERGY EFFICIENT TRIGGERING OF APERIODIC CHANNEL STATE REPORTS

(71) Applicant: QUALCOMM Incorporated, San Diego, CA (US)

(72) Inventors: Hemant SAGGAR, San Diego, CA (US); Igor GUTMAN, Hod HaSharon (IL); Tao LUO, San Diego, CA (US); Kazuki TAKEDA, Minato-ku (JP)

(21) Appl. No.: 19/086,086

(22) Filed: Mar. 20, 2025

(51) Int. Cl. H04W 52/02; H04W 76/27

(52) U.S. Cl. CPC H04W 52/0235; H04W 76/27

(57) ABSTRACT

This disclosure provides methods, components, devices and systems for energy efficient triggering of aperiodic channel state reports. For example, the UE may receive a low power wake up signal (LP-WUS) that triggers an aperiodic channel state report and indicates that the UE is to refrain from initiating the inactivity timer associated with transmission of the aperiodic channel state report. In some other examples, the LP-WUS may indicate that the UE is to enter an active state to receive downlink control information (DCI) that requests the aperiodic channel state report but that the UE is to refrain from initiating the inactivity timer in response to receipt of the DCI. In some other examples, the UE may receive DCI that requests the aperiodic channel state report and that includes one or more bits indicating that the UE is to refrain from initiating the inactivity timer in response to receipt of the DCI.

### TECHNICAL FIELD

This disclosure relates generally to wireless communication, and more specifically to systems, devices, methods, and techniques associated with energy efficient triggering of aperiodic channel state reports.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include receiving a low power wake up signal (LP-WUS) that indicates the UE is to transition from an inactive state to an active state, receiving first control information that triggers one or more aperiodic channel state reports, receiving second control information that indicates the UE is to refrain from initiating an inactivity timer, transmitting, responsive to the first control information, the one or more aperiodic channel state reports while in the active state, and switching, after transmission of the one or more aperiodic channel state reports, from the active state to the inactive state in an absence of initiation of the inactivity timer.

A UE for wireless communications is described. The UE may include a processing system that includes processor circuitry and memory circuitry that stores code. The processing system may be configured to cause the UE to receive a LP-WUS that indicates the UE is to transition from an inactive state to an active state, receive first control information that triggers one or more aperiodic channel state reports, receive second control information that indicates the UE is to refrain from initiating an inactivity timer, transmit, responsive to the first control information, the one or more aperiodic channel state reports while in the active state, and switch, after transmission of the one or more aperiodic channel state reports, from the active state to the inactive state in an absence of initiation of the inactivity timer.

Another UE for wireless communications is described. The UE may include means for receiving a LP-WUS that indicates the UE is to transition from an inactive state to an active state, means for receiving first control information that triggers one or more aperiodic channel state reports, means for receiving second control information that indicates the UE is to refrain from initiating an inactivity timer, means for transmitting, responsive to the first control information, the one or more aperiodic channel state reports while in the active state, and means for switching, after transmission of the one or more aperiodic channel state reports, from the active state to the inactive state in an absence of initiation of the inactivity timer.

A non-transitory computer-readable medium storing code for wireless communications is described. The code may include instructions executable by one or more processors to receive a LP-WUS that indicates the UE is to transition from an inactive state to an active state, receive first control information that triggers one or more aperiodic channel state reports, receive second control information that indicates the UE is to refrain from initiating an inactivity timer, transmit, responsive to the first control information, the one or more aperiodic channel state reports while in the active state, and switch, after transmission of the one or more aperiodic channel state reports, from the active state to the inactive state in an absence of initiation of the inactivity timer.

In some examples of the method, UEs, and non-transitory computer-readable medium described herein, one or more fields of the LP-WUS include the first control information that triggers the one or more aperiodic channel state reports and the second control information that indicates the UE may be to refrain from initiating the inactivity timer.

In some examples of the method, UEs, and non-transitory computer-readable medium described herein, the one or more fields of the LP-WUS indicate whether to monitor one or more downlink channels during an ON duration after the LP-WUS.

In some examples of the method, UEs, and non-transitory computer-readable medium described herein, downlink control information (DCI) includes the first control information that triggers the one or more aperiodic channel state reports and one or more fields of the LP-WUS include the second control information that indicates the UE may be to refrain from initiating the inactivity timer responsive to receipt of the DCI, the first control information being received after the second control information.

In some examples of the method, UEs, and non-transitory computer-readable medium described herein, the LP-WUS indicates to monitor a physical downlink control channel during an ON duration after the LP-WUS and the method, apparatuses, and non-transitory computer-readable medium may include further operations, features, means, or instructions for monitoring the physical downlink control channel during the ON duration, where receiving the first control information may be based on the monitoring, and where switching from the active state to the inactive state may be after the ON duration.

In some examples of the method, UEs, and non-transitory computer-readable medium described herein, DCI includes the first control information that triggers the one or more aperiodic channel state reports and the second control information that indicates the UE may be to refrain from initiating the inactivity timer responsive to receipt of the DCI.

In some examples of the method, UEs, and non-transitory computer-readable medium described herein, the DCI indicates whether to monitor one or more downlink channels during a duration after the DCI.

### BRIEF DESCRIPTION OF THE DRAWINGS

FIG. 1 shows an example of a wireless communication system.

FIG. 2 shows an example of a signaling diagram that supports energy efficient triggering of aperiodic channel state reports.

FIG. 3 shows an example of a signaling diagram that supports energy efficient triggering of aperiodic channel state reports.

FIG. 4 shows an example of a process flow that supports energy efficient triggering of aperiodic channel state reports.

FIG. 5 shows a block diagram of a processing system that supports energy efficient triggering of aperiodic channel state reports.

FIG. 6 shows a diagram of a system including a device that supports energy efficient triggering of aperiodic channel state reports.

FIG. 7 shows a flowchart illustrating methods that support energy efficient triggering of aperiodic channel state reports.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communications systems, a user equipment (UE) may receive downlink control information (DCI) that requests (e.g., triggers) an aperiodic channel state report (e.g., a channel state information (CSI) report, a channel state feedback (CSF) report) and includes an uplink grant (e.g., scheduling of uplink resources) for the channel state report. In response to receiving the uplink grant, the UE may trigger initiation (e.g., or reset) of an inactivity timer at the UE, and the UE may monitor a physical downlink control channel (PDCCH) for a duration of the inactivity timer (e.g., 80-100milliseconds). In some examples, the UE may receive a request for an aperiodic channel state report irrespective of a presence of uplink or downlink data (e.g., even when no downlink data is scheduled and/or no uplink data is buffered and waiting to be scheduled). The request for the aperiodic channel state report that the UE receives may trigger initiation of the inactivity timer at the UE, and the UE may waste energy monitoring the PDCCH unnecessarily.

Aspects of the subject matter described in this disclosure relate to energy efficient triggering of aperiodic channel state reports without initiation of the inactivity timer at the UE. For example, the UE may receive a low power wake up signal (LP-WUS) that triggers the aperiodic channel state report via a payload (e.g., one or more fields) of the LP-WUS and may indicate that the UE is to refrain from initiating the inactivity timer. In some other examples, the LP-WUS may indicate that the UE is to enter an active state (e.g., wake up, monitor PDCCH) to receive DCI that requests the aperiodic channel state report but that the UE is to refrain from initiating the inactivity timer in response to receipt of the DCI. For example, the LP-WUS may indicate that the UE is to remain in the active state for an ON duration that includes transmission of the requested aperiodic channel state report and to return to an inactive state (e.g., sleep) thereafter. In some other examples, the UE may receive DCI that requests the aperiodic channel state report and that includes one or more bits indicating that the UE is to refrain from initiating the inactivity timer in response to receipt of the DCI.

Particular aspects of the subject matter described in this disclosure can be implemented to realize one or more of the following potential advantages. In some examples, by refraining from initiating an inactivity timer at the UE responsive to an aperiodic channel state request, the described techniques can be used to reduce a time spent by the UE monitoring the PDCCH and to enable the UE to remain in a low power mode for longer, which may reduce power consumption and processing, promote energy savings, and extend a battery life of the UE.

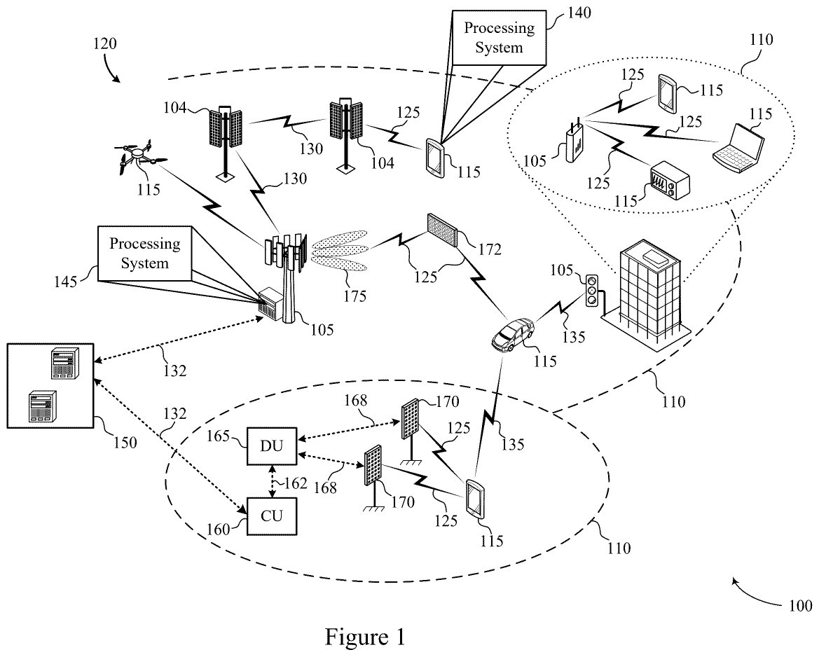

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating DCI (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, CSI-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for energy efficient triggering of aperiodic channel state reports. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support reducing a time spent by the UE monitoring the PDCCH and enabling the UE to remain in a low power mode for longer, which may reduce power consumption and processing, promote energy savings, and extend a battery life of one or more devices (e.g., a UE 115) in the wireless communication system 100.

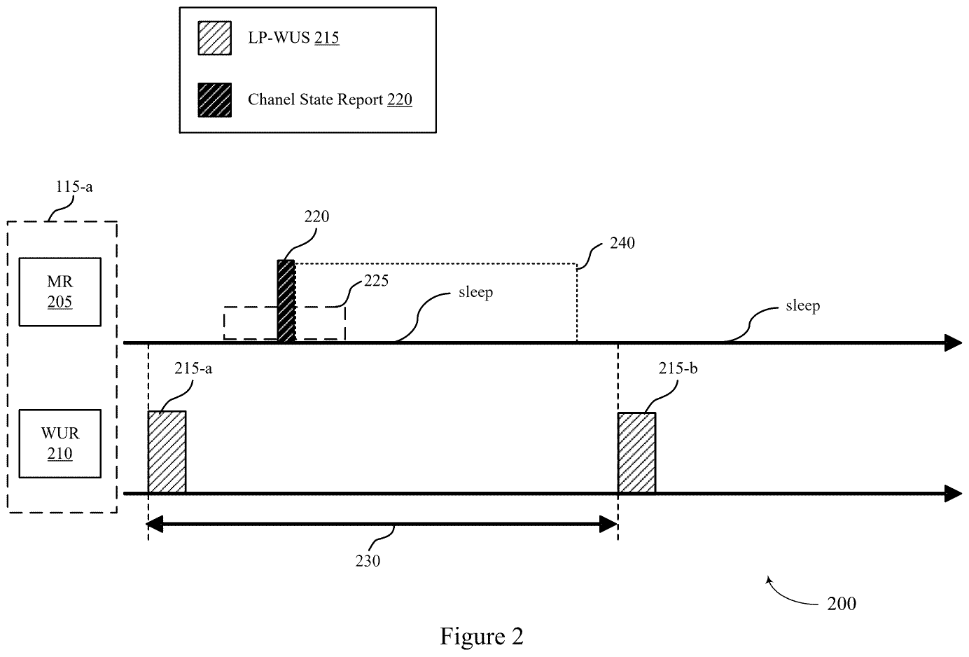

FIG. 2 shows an example of a signaling diagram 200 that supports energy efficient triggering of aperiodic channel state reports. The signaling diagram 200 may implement or be implemented by aspects of the wireless communication system 100. For example, the signaling diagram 200 may include a main radio (MR) 205 and a wake up receiver (WUR) 210 implemented in (e.g., components of) a UE 115-b, which may be an example of a UE 115 as described herein. The signaling diagram 200 may illustrate one or more messages, such as an LP-WUS 215 and a channel state report 220, which may be communicated between a network entity 105 and the UE 115-b.

In some wireless communication systems, a UE may be in a discontinuous reception (DRX) mode and an energy consumption of the UE may be predominately based on a connected DRX (C-DRX) duration 230 of the UE (e.g., an amount of time the UE is in a C-DRX state). For example, an energy consumption of the UE during an idle DRX duration (e.g., an amount of time the UE is in an idle DRX state) may be much smaller relative to during the C-DRX duration. An energy consumption by the UE may be based on how long the UE is in an active state or monitoring PDCCH, which may be a function of various timers such as an ON duration timer, an inactivity timer 240, or a retransmission timer, among others. The ON duration timer may correspond to an ON duration 225 (e.g., a DRX ON duration), which may be refer to a time period at a beginning portion of a DRX period (e.g., a portion of the C-DRX duration 230) during which the UE monitors the PDCCH.

In some cases, the UE may receive a downlink or uplink grant that starts (e.g., or restarts) the inactivity timer 240((e.g., 80-100ms). For example, if the PDCCH (e.g., via DCI) indicates a new transmission (e.g., downlink transmission, uplink transmission, sidelink transmission) on a serving cell in a DRX group of the UE, a group of UEs in the DRX group including the UE may start or restart the inactivity timer 240 in a first symbol after the end of the PDCCH reception.

In some cases, however, a network entity may transmit an uplink grant to request an aperiodic channel state report 220((e.g., CSI report, CSF report) even when no data is present (e.g., even when no downlink data is scheduled and/or no uplink data is buffered and waiting to be scheduled), which may trigger initiation of the inactivity timer 240 and cause the UE 115-b to waste energy monitoring the PDCCH unnecessarily. For example, the request for the aperiodic channel state report 220 may be transmitted with an uplink grant in the DCI, and the UE that receives the uplink grant may trigger initiation of the inactivity timer 240 and monitor the PDCCH while the inactivity timer 240 is running. In some examples, the network entity may transmit requests for aperiodic channel state reports relatively frequently even in time periods of sparse traffic, which may result in inefficient use of energy at the UE due to monitoring the PDCCH.

In accordance with examples described herein, the network entity may implement one or more energy efficient signaling mechanisms for requesting aperiodic channel state reports. For example, the one or more energy efficient signaling mechanisms may include LP-WUS triggered channel state reports and DCI and/or medium access control-control element (MAC-CE) triggered channel state reports. In the example of LP-WUS triggered channel state reports, the WUR 210 of the UE 115-b may receive an LP-WUS 315-a that triggers the aperiodic channel state report 220. The LP-WUS triggered channel state reports may be associated with a relatively large energy savings compared with other signaling mechanisms. In some examples, a performance and/or feasibility of the LP-WUS triggered channel state reporting may be dependent on a coverage of the LP-WUS 215-a or an available payload size in the LP-WUS 215, or both. In the example of DCI and/or MAC-CE triggered channel state reports, one or more characteristics of the DCI or the MAC-CE may allow for a relatively higher flexibility of channel state report triggering. In some examples, one or more additional fields (e.g., bits) may be added to an existing payload of the DCI or MAC-CE to support the triggering aspects. Additionally, or alternatively, a network entity may implement a combination of the LP-WUS and the DCI and/or MAC-CE based triggering to leverage the benefits of each.

In the example of FIG. 2, the WUR 210 of the UE 115-a may receive the LP-WUS 215 triggering a channel state report request (e.g., CSI request) via its payload. The LP-WUS 215 may include in its payload the request for the channel state report along with an uplink grant for the channel state report, a resource configuration (e.g., CSI resource configuration) for the channel state report, a report configuration (e.g., CSI report setting) for the channel state report, or a combination thereof.

The UE 115-a may or may not monitor a PDCCH (e.g., may or may not wake up the MR 205 to monitor the PDCCH) during an ON duration 225 ON duration after the LP-WUS 215-a. In some examples, the UE may receive control signaling (e.g., RRC, DCI, MAC-CE) that indicates whether the UE 115-a is to monitor the PDCCH during the ON duration 225 after the LP-WUS 215-a. Additionally, or alternatively, the LP-WUS 215-amay indicate, via its payload, whether the UE 115-a is to monitor the PDCCH during the ON duration 225. For example, the LP-WUS 215-a may indicate not to wake up the MR 205, and the UE 115-a may refrain from initiating a timer corresponding to the ON duration 225 (e.g., an ON duration timer). Alternatively, the LP-WUS 215-a may indicate to wake up the MR 205 (e.g., to transmit downlink data). In this case, the UE 115-a may initiate the timer corresponding to the ON duration 225 and may monitor the PDCCH for the ON duration 225.

The UE 115-a may refrain from starting the inactivity timer 240 associated with receipt of the channel state report grant (e.g., receipt of an uplink grant that is included in the LP-WUS 215-a with the channel state report request). The MR 205 of the UE 115-a may wake up (e.g., switch from an inactive state to an active state) to send the channel state report 220 or to measure one or more channel state reference signals (e.g., CSI-RSs) responsive to the LP-WUS 215-a. For example, the MR 205 may wake up for a ON duration 225 that extends just long enough for the UE 115-a to measure channel state reference signals and/or transmit the channel state report 220, and may return to sleep after (e.g., immediately after) the ON duration 225 has elapsed. The MR 205 or the WUR 210, or both may perform CSI-related measurements (e.g., CSI-RS or synchronization signal block (SSB) measurements) for the channel state report 220. In some cases, the WUR 210 may use less energy for performing the CSI-related measurements relative to the MR 205.

In some examples, the LP-WUS 215-a may include, via its payload, one or more parameters associated with the LP-WUS triggered channel state report 220. Additionally, or alternatively, the UE may receive the parameters via control signaling (e.g., RRC, DCI, MAC-CE) that configures the parameters associated with the LP-WUS triggered channel state report 220 using a same or similar format (e.g., one or more tables) as that used in DCI triggering of channel state reports.

In some examples, the channel state report 220 may be event-based triggered, and the UE 115-a may transmit the channel state report 220 based on satisfaction of one or more event-based criteria. For example, the UE 115-a may wake up the MR 205 based on receiving the channel state report request via the LP-WUS 215-a and the one or more event-based criteria being satisfied. If the event criteria is not satisfied, the MR 205 may skip the channel state report 220 and may remain asleep (e.g., in the inactive state) during the ON duration 225, which may provide energy savings relative to DCI triggering of channel state reports.

The event-based criteria may be based on one or more measurements (e.g., CSI-related measurements on CSI-RSs or SSBs) that the MR 205 or the WUR 210 performs. For example, the event-based criteria may be based on reference signal received power (RSRP) measurements, one or more reference signal received quality (RSRQ) measurements, one or more signal-to-interference noise ratio (SINR) measurements, one or more CSI-RS resource indices (CRIs), one or more SSB resource indices (SSBRIs), or a combination thereof. In one example, the event-based criteria may include whether a best measured downlink beam is different from an active downlink beam or from a last reported best downlink beam. In another example, the event-based criteria may include whether none of a previous set of top-K reported downlink beams are in a current set of top-K downlink beams. In another example, the event-based criteria may include whether the RSRP of one or more of the measured resources (e.g., reference signals, beams) changed (e.g., increased, decreased) by more than a threshold value relative to a previous report.

In some examples, the WUR of the UE 115-a may receive an LP-WUS 215-b that does not include a request for a channel state report in its payload. For example, the UE 115-a may receive the LP-WUS 215-b at some time after the LP-WUS 215-a(e.g., at an expiration of the C-DRX duration 230). The MR 205 may remain asleep in response to the LP-WUS 215-b and may refrain from monitoring the PDCCH.

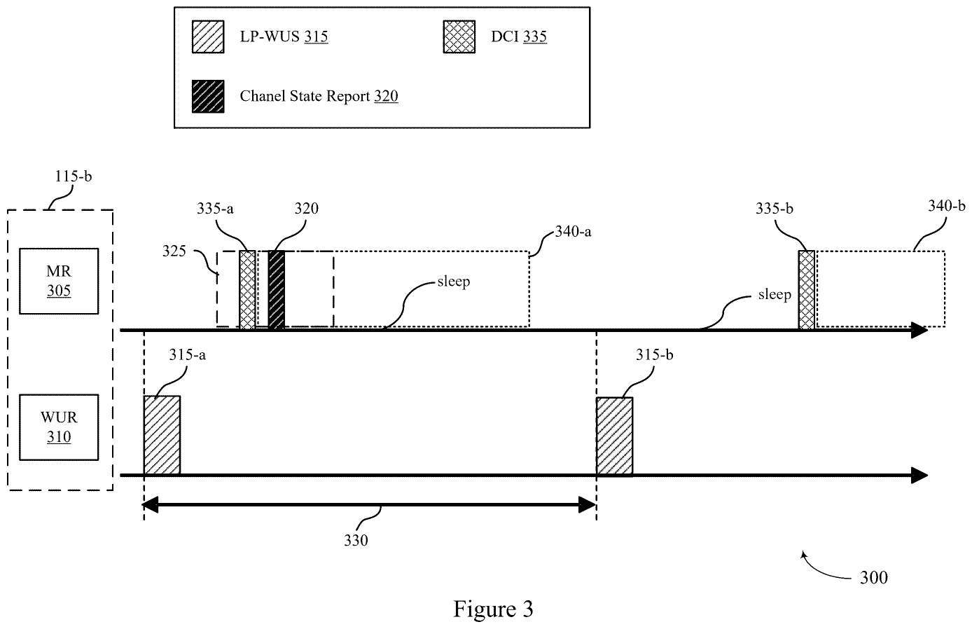

FIG. 3 shows an example of a signaling diagram 300 that supports energy efficient triggering of aperiodic channel state reports. The signaling diagram 300 may implement or be implemented by aspects of the wireless communication system 100. For example, the signaling diagram 300 may include a MR 305 and a WUR 310, which may be implemented in (e.g., may be components of) a UE 115, as described with reference to FIG. 1. The signaling diagram 300 may illustrate one or more messages, such as an LP-WUS 315 and DCI 335, which may be communicated between a network entity 105 and a UE 115.

In the example of FIG. 3, the WUR 310 of the UE 115-b may receive an LP-WUS 315-a that indicates the MR 305 of the UE 115-b is to wake up and monitor the PDCCH (e.g., during an ON duration 325) for DCI 335-a that includes a request for a channel state report 320. For example, the LP-WUS 315-a may indicate a presence of the DCI 335-a and/or that the DCI 335-a follows the LP-WUS 315-a. Additionally, or alternatively, the LP-WUS 315-a may indicate that the UE 115-b is to refrain from initiating the inactivity timer 340-a or is to refrain from monitoring the PDCCH, or both responsive to receipt of the DCI 335-a.

The UE 115-b may initiate a timer corresponding to an ON duration 325 (e.g., an ON duration timer) and may monitor the PDCCH during the ON duration 325. The UE 115-b, via the MR 305, may receive the DCI 335-a during the ON duration 325, and the DCI 335-a may include a request for the channel state report 320. For example, the DCI 335-a may include the channel state report request along with an uplink grant for the channel state report 320, a resource configuration for the channel state report 320, a report configuration for the channel state report 320, or a combination thereof. Since the UE 115-b expects the receipt of the DCI 335 (e.g., based on having received the LP-WUS 315-a indicating the presence of the DCI 335-a or to refrain from initiating the inactivity timer 340-a), the UE 115-b may refrain from initiating the inactivity timer 340-a upon reception of the DCI 335. Accordingly, the MR 305 may return to sleep (e.g., switch from the active state to the inactive state) after the ON duration 325 and may remain asleep during a duration corresponding to the inactivity timer 340-a.

In some examples, the UE 115-b may receive DCI 335-b that schedules one or more downlink or uplink messages (e.g., data messages) and excludes a request for a channel state report (e.g., no request for a CSI report is present in its payload). In such examples, the UE 115-b may initiate an inactivity timer 340-b upon receipt of the DCI 335-b. The MR 305 of the UE 115-b may monitor the PDCCH during a duration corresponding to the inactivity timer 340-b and may communicate the downlink or uplink messages during the duration. In some examples, the UE 115-b may receive the DCI 335-b during a same CDRX duration 330 as the DCI 335-a or during a different CDRX duration. The UE 115-b may receive the DCI 335-b after receipt of a LP-WUS 315-b, in some examples.

In some examples, the UE 115-b may be outside of a coverage area of the LP-WUS 315-a but within a coverage area of the DCI 335-a (e.g., PDCCH). In such examples, the UE 115-b may wakeup (e.g., according to a default RRC setting, during the ON duration 325) to monitor the PDCCH, may receive the DCI 335-a with the request for the channel state report 320, and may transmit the channel state report 320. In this case, because the UE 115-b failed to receive the LP-WUS 315-a, the UE 115-b may initiate the inactivity timer 340-a based on receipt of the uplink grant in the DCI 335-a.

In some examples, the DCI 335-a may include the request for the channel state report 320 and may indicate, via one or more fields (e.g., CSI report configuration fields) of the request for the channel state report 320, that the DCI 335-a does not trigger the inactivity timer 340-a (e.g., despite including an uplink grant). Additionally, or alternatively, the one or more fields of the channel state report request may indicate that the UE is to refrain from monitoring the PDCCH for a duration (e.g., of the inactivity timer 340-a) after receipt of the DCI 335-a. In such examples, the MR 305 may remain awake during the ON duration 325 (e.g., ON duration) and may return to a sleep state and remain in the sleep state during a duration corresponding to the inactivity timer 340-a. In some examples, a MAC-CE or other control signaling may semi-statically change a behavior of the one or more fields of the channel state report request.

In some examples, one or more first bits in a DCI 335 may indicate whether to start, restart, or refrain from starting an inactivity timer 340 after (e.g., based on) the reception of the DCI 335-a. The one or more bits may be present in DCIs 335 (e.g., the DCI 335-a) which request a channel state report 320. Additionally, or alternatively, the one or more bits may be present in any DCI 335 with a grant, which in some cases may include DCIs 335 (e.g., the DCI 335-b) without a request for a channel state report 320. In some examples, the one or more bits in the DCI 335 may indicate a duration of the inactivity timer 340. In some examples, the one or more bits of the DCI 335 may indicate a duration type for the inactivity timer 340 from a set of duration types, which may include a short duration (e.g., 10milliseconds), a medium duration (e.g., 50milli seconds), and a long duration (e.g., 100milliseconds).

In some examples, the indicated duration of the inactivity timer 340 may be based on one or more contents within the DCI 335. For example, the inactivity timer 340-a for the DCI 335-a may be a relatively shorter duration based on the DCI 335-aincluding the channel state report request, whereas the inactivity timer 340-b for the DCI 335-b may be a relatively longer duration based on the DCI 335-b including a downlink grant. After receiving a channel state report 320 (e.g., associated with a small inactivity timer 340), the network entity may determine whether channel conditions justify further CSI reports (e.g., updated precoding matrix indicator (PMI), channel quality indicator (CQI), rank indicator (RI)) and may send further DCIs 335 (associated with relatively longer inactivity timers 340), may schedule data to the UE 115-b, or both. Accordingly, the inactivity monitoring and UE 115-b energy consumption may be optimized to channel and network conditions.

In some examples, the UE 115-b may receive control signaling (e.g., RRC, MAC-CE) that indicates a set of trigger states associated with the aperiodic channel state report 320 and a set of inactivity timer behaviors each corresponding to a respective one of the set of trigger states. For example, the set of trigger states and the set of inactivity timer behaviors may be indicated via one or more look-up tables. In such examples, the DCI 225-a that triggers the aperiodic channel state report 320 may indicate (e.g., select) one of the set of trigger states, and the UE 115-b may determine whether to initiate the inactivity timer 340-a based on the inactivity timer behavior corresponding to the indicated trigger state.

In some examples, trigger states in the set of trigger states may be mapped to a specific behavior to start an inactivity timer or not via a table (e.g., CSI-aperiodicTriggerStateList mapping table) that can be updated using MAC-CE or RRC. A CSI request codepoint in the DCI 335 may select the trigger state and the desired inactivity timer behavior. In some examples, the network entity may have flexibility to trigger an inactivity timer 340 in some instances and not in other instances, when requesting a channel state report 320. For example, a table for indicating the set of trigger states may be expanded to include mapping information that maps each trigger state to a corresponding inactivity timer imitation behavior (e.g., a subset of the trigger states apply the exempted inactivity timer rules described herein). By adding the mapping information associated with inactivity timer behavior, the look up table may be doubled in size (e.g., 128 entries). Half of the trigger state entries in the table may trigger inactivity timer, while the remaining half of the trigger state entries may not. Other details in the table may still be present in the table (e.g., CSI resource configuration, CSI report configuration).

For the same CSI resource, two inactivity timer behaviors (e.g., triggered to start, not triggered to start) may be selectable through separate codepoints. A MAC-CE message (e.g., an aperiodic CSI trigger state subselection MAC CE) may be used to map DCI code points to up to 64 of the trigger state entries in the table. Based on which code point is signaled in a CSI request field (e.g., up to 6 bits) of the DCI 335, the UE 115-b may determine whether to trigger the inactivity timer 340 or not based on the inactivity timer behavior that corresponds to the DCI code point as indicated by the CSI-aperiodicTriggerStateList mapping table. With this scheme, the network entity may be capable of configuring 63 CSI request code points as to whether or not inactivity timers 340 are triggered.

A behavior of the UE 115-b of whether to trigger the inactivity timer 340-a may be updated by sending an updated MAC CE (e.g., the aperiodic CSI trigger state subselection MAC CE) with an updated mapping of the entries (e.g., up to 64 entries) of the CSI-aperiodicTriggerStateList mapping table. Such a change may, in some cases, be transmitted to the UE 115-b intermittently (e.g., periodically or when active beams change or reporting is requested to change). In some examples, pairs of trigger states may be provided a same CSI resources but different inactivity behaviors.

Additionally, or alternatively, a second table (e.g., TriggerStateToInactivityBehaviorMapping) different from the CSI-aperiodicTriggerStateList mapping table may map each trigger state to an inactivity initiation behavior. Such a table may map whether inactivity timer is (re)started or not when the UE 115-b receives a certain trigger state (codepoint). In some examples, a new MAC-CE may be defined to update this table. The table may list active trigger states (e.g., less than 63) of or all trigger states (e.g., up to 63 currently). In this way, each CSI resource may be tied to a single inactivity timer behavior and any change may use a new MAC-CE.

In some examples, a MAC-CE may be used to update the inactivity (re)starting behavior mapping tables. However, in some examples, sending a MAC-CE may trigger an inactivity timer 340 and may waste power. Alternatively, some indication in the DCI 335 may be sent indicating that the downlink grant included in the DCI 335 is to deliver an updated MAC-CE related to inactivity timer behavior. In such cases, the UE 115-b may not (re)start the inactivity timer based on receiving the downlink grant.

In some examples, whether or not to initiate the inactivity timer 340-a after a DCI 335-a containing a channel state report request may be controlled via MAC-CE or RRC signaling (e.g., instead of through DCI codepoint). A new MAC-CE or RRC reconfiguration may be sent whenever the inactivity behavior is to be changed for future slots.

In some examples, the UE 115-b may refrain from initiating the inactivity timer 340-a based on an indication in the DCI payload and based on the CSI request being received within the C-DRX duration 330. Otherwise, if the DCI 335-a is received outside of the C-DRX duration 330, the UE 115-b may initiate the inactivity timer 340-a. Additionally, or alternatively, the UE 115-b may refrain from restarting (e.g., reinitiating) the inactivity timer 340-a based on the CSI request being received within the C-DRX duration 330 and based on a determination that an inactivity timer 340 is already running. In some examples, the UE 115-b may refrain from initiating the inactivity timer based on an indication in the DCI payload and based on the CSI request being based on periodic signals, semi-persistent signals, aperiodic signals, or a combination thereof. For example, the UE 115-b may not trigger the inactivity timer 340-a when a report requested by the DCI 335-a is based on one or more periodic (e.g., CSI-RS) measurements.

Though described in the context of triggering, via the DCI 335-a, of aperiodic channels state reports 320, the techniques described herein may also be applicable triggering, via DCI 335, of one or more semi-persistent reports on a physical uplink shared channel (PUSCH). In some examples, in cases where the UE 115-b does not start (or re-start) the inactivity timer 340-a, a network entity may calculate a new inactive time and may not transmit signals (e.g., periodic and semi-persistent CSI-RS, TRS) which are not monitored by the UE 115-b. Additionally, or alternatively, the network entity may not receive signals (e.g., periodic and semi-persistent SRS) which are not transmitted by the UE 115-b in the inactive time.

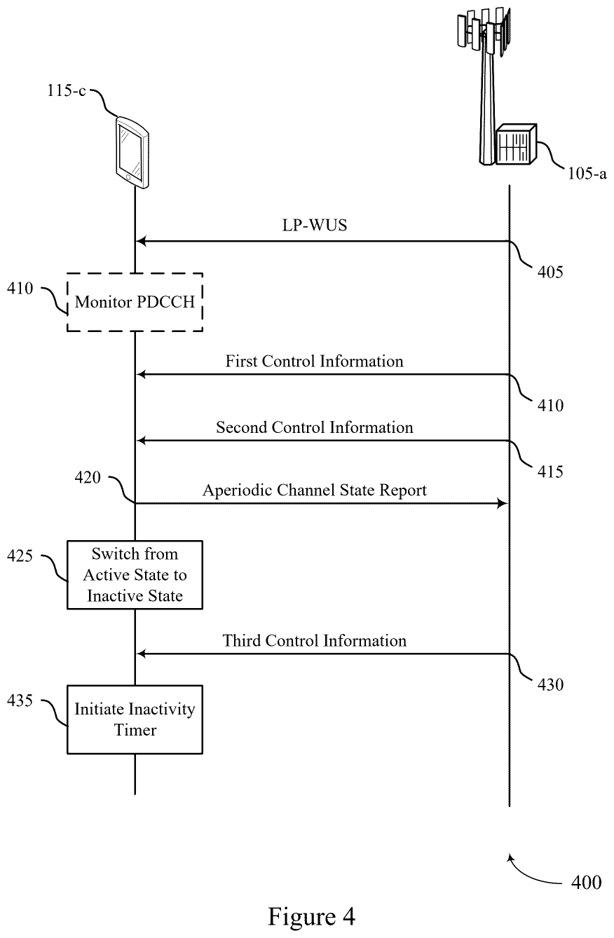

FIG. 4 shows an example of a process flow 400 that supports energy efficient triggering of aperiodic channel state reports. The process flow 400 may implement or be implemented by aspects of the wireless communication system 100. For example, the process flow 400 may include a UE 115-a and a network entity 105-a, which may be examples of corresponding devices described herein. In the following description of the process flow 400, the operations may be performed in a different order than the order shown, or the operations performed by the example devices may be performed in different orders or at different times. For example, specific operations also may be left out of the process flow 400, or other operations may be added to the process flow 400. Further, although some operations or signaling may be shown to occur at different times for discussion purposes, these operations may actually occur at the same time.

At 405, the UE 115-c may receive an LP-WUS that indicates the UE 115-c is to transition from an inactive state (e.g., sleep, CDRX idle state) to an active state (e.g., wake, active state, CDRX connected state).

At 410, the UE 115-c may monitor a PDCCH for an ON duration ON duration after the LP-WUS. In some examples, the LP-WUS may include one or more fields indicating whether to monitor the PDCCH for the ON duration after the LP-WUS, and the UE 115-c may monitor or refrain from monitoring the PDCCH based on one or more fields in the LP-WUS. In some examples, the LP-WUS may indicate the UE is to monitor the PDCCH for DCI that request a channel state report. The LP-WUS may indicate a presence of the DCI including the request for the channel state report or that the DCI is expected to follow the LP-WUS, or both.

At 415, the UE 115-c may receive first control information that triggers one or more aperiodic channel state reports (e.g., CSI report, CSF report). In some examples, the LP-WUS may include the first control information in its payload (e.g., in one or more fields of the LP-WUS) and may additionally include one or more parameters associated with the channel state report. For example, the one or more parameters may include an uplink grant for the channel state report, a resource configuration (e.g., an indicated set of CSI-RS resources) for the channel state report, and a report configuration for the channel state report (e.g., the UE 115-c may have sufficient information to transmit the requested channel state report without receipt of separate DCI signaling). In some other examples, DCI may include the first control information, and the DCI may include the one or more parameters associated with the channel state report.

At 420, the UE 115-c may receive second control information that indicates the UE 115-c is to refrain from initiating (e.g., starting, restarting) an inactivity timer (e.g., responsive to receipt by the UE 115-c of a request for the aperiodic channel state report, responsive of transmission of the aperiodic channel state report by the UE 115-c, or both). In some examples, the LP-WUS may include the second control information in its payload (e.g., in one or more fields of the LP-WUS). In some other examples, the DCI may include both the first control information and the second control information. The second control information may also indicate whether to monitor the PDCCH during an ON duration after receipt of the first control information.

At 420, the UE 115-c may transmit the aperiodic channel state information report that is triggered by the first control information. The UE 115-c may transmit the aperiodic channel state information report according to the parameters indicated in the first control information. At 425, the UE 115-c may switch from the active state to the inactive state after transmission of the channel state report in an absence of initiation of the inactivity timer. For example, the UE 115-c may refrain from initiating an inactivity timer responsive to an uplink grant included in the first control information. Accordingly, no inactivity timer may be running at the UE 115-c after transmission of the channel state report, and the UE 115-c may return to a sleep state and may not monitor the PDCCH.

At 430, the UE 115-c may receive third control information (e.g., DCI) that schedules one or more uplink or downlink messages (e.g., data messages) and that excludes a request for a channel state report. Based on the third control information excluding any request for a channel state report, the UE 115-c may, at 435, initiate an inactivity timer and monitor the PDCCH during a duration of the inactivity timer.

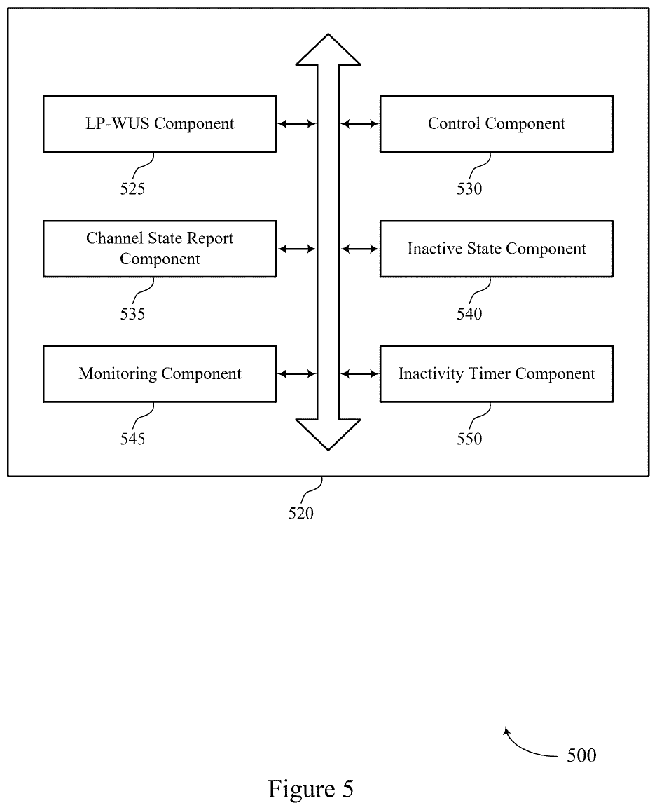

FIG. 5 shows an example of a processing system 520 that supports energy efficient triggering of aperiodic channel state reports. A processing system 520 may be an example of a processing system 140 (such as of a UE 115) and may include an LP-WUS component 525, a control component 530, a channel state report component 535, an inactive state component 540, a monitoring component 545, an inactivity timer component 550, or any combination thereof. A processing system 520, or various component thereof, may be an example of means for performing (such as a means for causing a UE 115 to perform) various techniques described herein.

The LP-WUS component 525 may be configured to cause the UE 115 to receive a LP-WUS that indicates the UE is to transition from an inactive state to an active state. The control component 530 may be configured to cause the UE 115 to receive first control information that triggers one or more aperiodic channel state reports. In some examples, the control component 530 may be configured to cause the UE 115 to receive second control information that indicates the UE is to refrain from initiating an inactivity timer. The channel state report component 535 may be configured to cause the UE 115 to transmit, responsive to the first control information, the one or more aperiodic channel state reports while in the active state. The inactive state component 540 may be configured to cause the UE 115 to switch, after transmission of the one or more aperiodic channel state reports, from the active state to the inactive state in an absence of initiation of the inactivity timer.

In some examples, one or more fields of the LP-WUS include the first control information that triggers the one or more aperiodic channel state reports and the second control information that indicates the UE is to refrain from initiating the inactivity timer.

In some examples, the one or more fields of the LP-WUS indicate whether to monitor one or more downlink channels during an ON duration after the LP-WUS.

In some examples, DCI includes the first control information that triggers the one or more aperiodic channel state reports. In some examples, one or more fields of the LP-WUS include the second control information that indicates the UE is to refrain from initiating the inactivity timer responsive to receipt of the DCI, the first control information being received after the second control information.

In some examples, the LP-WUS indicates to monitor a physical downlink control channel during an ON duration after the LP-WUS, and the monitoring component 545 may be configured to cause the UE 115 to monitor the physical downlink control channel during the ON duration, where receiving the first control information is based on the monitoring, and where switching from the active state to the inactive state is after the ON duration.

In some examples, DCI includes the first control information that triggers the one or more aperiodic channel state reports and the second control information that indicates the UE is to refrain from initiating the inactivity timer responsive to receipt of the DCI.

In some examples, the DCI indicates whether to monitor one or more downlink channels during an ON duration after the DCI.

In some examples, the first control information includes a request for an aperiodic CSI report or for an aperiodic CSF report.

In some examples, to support receiving the second control information, the control component 530 may be configured to cause the UE 115 to receive configuration information associated with the request for the aperiodic CSI report or for the aperiodic CSF report, the configuration information indicating the UE is to refrain from initiating the inactivity timer responsive to receipt of the request for the aperiodic CSI report or for the aperiodic CSF report.

In some examples, to support transmitting the one or more aperiodic channel state reports, the channel state report component 535 may be configured to cause the UE 115 to transmit the one or more aperiodic channel state reports based on satisfaction of the one or more event-based criteria.

In some examples, the one or more event-based criteria are based on one or more RSRP measurements, one or more RSRQ measurements, one or more SINR measurements, one or more CRIs, one or more SSBRIs, or a combination thereof.

In some examples, the control component 530 may be configured to cause the UE 115 to receive, after receiving the first control information, third control information that schedules one or more uplink or downlink messages and excludes a request for a channel state report. In some examples, the inactivity timer component 550 may be configured to cause the UE 115 to initiate the inactivity timer responsive to receipt of the third control information that excludes the request for the channel state report.

In some examples, the LP-WUS indicates to refrain from monitoring one or more downlink channels and indicates the UE is to transition to the active state until transmission of the one or more aperiodic channel state reports.

In some examples, the LP-WUS indicates one or more parameters associated with the one or more aperiodic channel state reports. In some examples, transmitting the one or more aperiodic channel state reports is in accordance with the one or more parameters.

In some examples, the control component 530 may be configured to cause the UE 115 to receive DCI including one or more first bits indicating whether to initiate the inactivity timer responsive to receipt of the DCI, one or more second bits indicating a duration of the inactivity timer, or both, the second control information being the one or more first bits of the DCI.

In some examples, the second control information indicates a set of multiple trigger states associated with the one or more aperiodic channel state reports and a set of multiple inactivity timer behaviors each corresponding to a respective one of the set of multiple trigger states. In some examples, the first control information that triggers the one or more aperiodic channel state reports indicates one of the set of multiple trigger states.

A processing system 520 may include or be a component of one or more chips, systems-on-chips (SoCs), chipsets, packages, components, or devices that individually or collectively constitute or include a processing system. A processing system 520 may interface with other components of a processing system 520. For example, operations described with reference to a processing system 520, or various components thereof, may be performed by or with other such components, including a receiver, a transmitter, a transceiver, a modem, a user interface, a modulator/demodulator, an encoder/decoder, or any combination thereof (such as of the processing system 520, coupled with the processing system 520, of a processing system 520).

By including or configuring a processing system 520 for operation in a processing system 520 as described herein, the processing system 520 may support techniques for reduced processing, reduced power consumption, and more efficient utilization of communication resources.

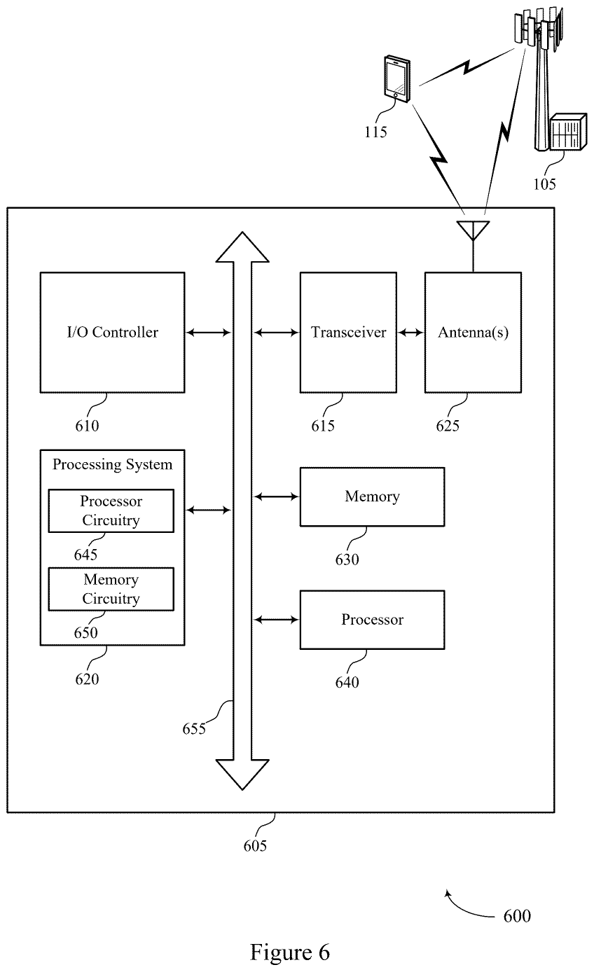

FIG. 6 shows an example of a system 600 including a device 605 that supports energy efficient triggering of aperiodic channel state reports. The device 605 may be an example of or include components of UE 115. The device 605 may communicate (such as wirelessly) with one or more other devices (such as network entities 105, UEs 115). The device 605 may include components for transmitting and receiving communication, which may include a processing system 620, an input/output (I/O) controller, such as an I/O controller 610, a transceiver 615, antenna(s) 625, a memory 630, and a processor 640. Components of the device 605 may be coupled (such as operatively, communicatively, functionally, electronically, electrically, in electronic communication) a bus 655.

The transceiver 615 may support bi-directional communication via antenna(s) 625, and may support transmission operations, reception operations, or both, as described herein. The transceiver 615 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 605). The transceiver 615 may modulate symbols and provide the modulated symbols to antenna(s) 625 for transmission, and demodulate symbols from signals received using antenna(s) 625.

The processor 640 may be a general-purpose processing component that supports various operations (such as applications) of the device 605. The memory 630 may be a general-purpose storage component that stores code executable by the processor 640. Such code may include instructions that, when executed by the processor 640, cause the device 605 to perform various functions (such as to support an application of the device 605). The I/O controller 610 may manage inputs and outputs for the device 605, may manage peripherals not integrated into the device 605, or may represent a physical connection (such as port) to an external peripheral. The processor 640 may interact with a modem, a keyboard, a mouse, a touchscreen, or other device (such as via I/O controller 610). In some implementations, a user may interact with the device 605 via the I/O controller 610 or via hardware components controlled by the I/O controller 610.

The processing system 620 may be an example of a processing system 140 or a processing system 500. For example, the processing system 620 may include processor circuitry 645 and memory circuitry 650 that stores code, and may be configured to cause the device 605 to perform operations that support energy efficient triggering of aperiodic channel state reports. Although the processing system 620 is illustrated as a separate component, which may involve a separate chip, chipset, or other module, in some implementations, one or more functions described with reference to the processing system 620 may be supported by or performed by a transceiver 615, antenna(s) 625, a processor 640, memory 630, or any combination thereof, such that a processing system 620 may include one or more of a transceiver 615, antenna(s) 625, a processor 640, memory 630, or any combination thereof.

By including or configuring the processing system 620 for operation in the device 605 as described herein, may support techniques for improved user experience related to reduced processing, reduced power consumption, more efficient utilization of communication resources, improved coordination between devices, longer battery life, and improved utilization of processing capability.

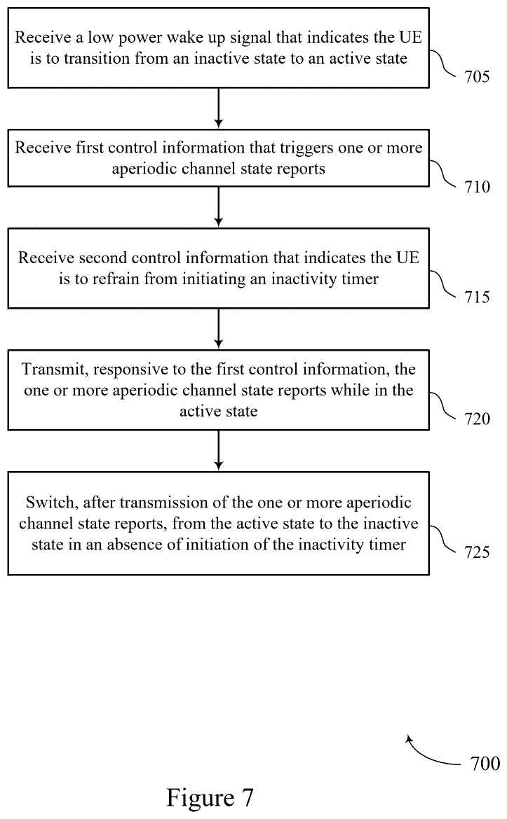

FIG. 7 shows an example of a method 700 that supports energy efficient triggering of aperiodic channel state reports. Operations of the method 700 may be performed by a UE or its components (such as using a processing system configured to cause the UE 115 to perform one or more of the operations) as described herein.

At 705, the method may include receiving a LP-WUS that indicates the UE is to transition from an inactive state to an active state. In some examples, aspects of the operations of 705 may be performed by an LP-WUS component 525.

At 710, the method may include receiving first control information that triggers one or more aperiodic channel state reports. In some examples, aspects of the operations of 710 may be performed by a control component 530.

At 715, the method may include receiving second control information that indicates the UE is to refrain from initiating an inactivity timer. In some examples, aspects of the operations of 715 may be performed by a control component 530.

At 720, the method may include transmitting, responsive to the first control information, the one or more aperiodic channel state reports while in the active state. In some examples, aspects of the operations of 720 may be performed by a channel state report component 535.

At 725, the method may include switching, after transmission of the one or more aperiodic channel state reports, from the active state to the inactive state in an absence of initiation of the inactivity timer. In some examples, aspects of the operations of 725 may be performed by an inactive state component 540.

The following provides an overview of aspects of the present disclosure:

Aspect 1: A method for wireless communications by a UE, comprising: receiving a LP-WUS that indicates the UE is to transition from an inactive state to an active state; receiving first control information that triggers one or more aperiodic channel state reports; receiving second control information that indicates the UE is to refrain from initiating an inactivity timer; transmitting, responsive to the first control information, the one or more aperiodic channel state reports while in the active state; and switching, after transmission of the one or more aperiodic channel state reports, from the active state to the inactive state in an absence of initiation of the inactivity timer.

Aspect 2: The method of aspect 1, wherein one or more fields of the LP-WUS comprise the first control information that triggers the one or more aperiodic channel state reports and the second control information that indicates the UE is to refrain from initiating the inactivity timer.

Aspect 3: The method of aspect 2, wherein the one or more fields of the LP-WUS indicate whether to monitor one or more downlink channels during an ON duration after the LP-WUS.

Aspect 4: The method of any of aspects 1 through 3, wherein DCI comprises the first control information that triggers the one or more aperiodic channel state reports, and one or more fields of the LP-WUS comprise the second control information that indicates the UE is to refrain from initiating the inactivity timer responsive to receipt of the DCI, the first control information being received after the second control information.

Aspect 5: The method of any of aspects 1 through 4, wherein the LP-WUS indicates to monitor a PDCCH during an ON duration after the LP-WUS, the method further comprising: monitoring the PDCCH during the ON duration, wherein receiving the first control information is based at least in part on the monitoring, and wherein switching from the active state to the inactive state is after the ON duration.

Aspect 6: The method of any of aspects 1 through 5, wherein DCI comprises the first control information that triggers the one or more aperiodic channel state reports and the second control information that indicates the UE is to refrain from initiating the inactivity timer.

Aspect 7: The method of aspect 6, wherein the DCI indicates whether to monitor one or more downlink channels during an ON duration after the DCI.

Aspect 8: The method of any of aspects 1 through 7, wherein the first control information comprises a request for an aperiodic CSI report or for an aperiodic CSF report.

Aspect 9: The method of aspect 8, wherein receiving the second control information comprises: receiving configuration information associated with the request for the aperiodic CSI report or for the aperiodic CSF report, the configuration information indicating the UE is to refrain from initiating the inactivity timer responsive to receipt of the request for the aperiodic CSI report or for the aperiodic CSF report.

Aspect 10: The method of any of aspects 1 through 9, wherein the first control information indicates one or more event-based criteria associated with triggering the one or more aperiodic channel state reports, wherein transmitting the one or more aperiodic channel state reports comprises: transmitting the one or more aperiodic channel state reports based at least in part on satisfaction of the one or more event-based criteria.

Aspect 11: The method of aspect 10, wherein the one or more event-based criteria are based at least in part on one or more RSRP measurements, one or more RSRQ measurements, one or more SINR measurements, one or more CRIs, one or more SSBRIs, or a combination thereof.

Aspect 12: The method of any of aspects 1 through 11, further comprising: receiving, after receiving the first control information, third control information that schedules one or more uplink or downlink messages and excludes a request for a channel state report; and initiating the inactivity timer responsive to receipt of the third control information that excludes the request for the channel state report.

Aspect 13: The method of any of aspects 1 through 12, wherein the LP-WUS indicates to refrain from monitoring one or more downlink channels and indicates the UE is to transition to the active state until transmission of the one or more aperiodic channel state reports.

Aspect 14: The method of any of aspects 1 through 13, wherein the LP-WUS indicates one or more parameters associated with the one or more aperiodic channel state reports, and transmitting the one or more aperiodic channel state reports is in accordance with the one or more parameters.

Aspect 15: The method of any of aspects 1 through 14, further comprising: receiving DCI comprising one or more first bits indicating whether to initiate the inactivity timer, one or more second bits indicating a duration of the inactivity timer, or both.

Aspect 16: The method of any of aspects 1 through 15, wherein the second control information indicates a plurality of trigger states associated with the one or more aperiodic channel state reports and a plurality of inactivity timer behaviors each corresponding to a respective one of the plurality of trigger states, and the first control information that triggers the one or more aperiodic channel state reports indicates one of the plurality of trigger states.

Aspect 17: A UE for wireless communications, comprising a processing system that includes processor circuitry and memory circuitry that stores code, the processing system configured to cause the UE to perform a method of any of aspects 1 through 16.

Aspect 18: A UE for wireless communications, comprising at least one means for performing a method of any of aspects 1 through 16.

Aspect 19: A non-transitory computer-readable medium storing code for wireless communications, the code comprising instructions executable by one or more processors to perform a method of any of aspects 1 through 16.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code) stored in memory circuitry or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive a low power wake up signal that indicates the UE is to transition from an inactive state to an active state;
receive first control information that triggers one or more aperiodic channel state reports;
receive second control information that indicates the UE is to refrain from initiating an inactivity timer;
transmit, responsive to the first control information, the one or more aperiodic channel state reports while in the active state; and
switch, after transmission of the one or more aperiodic channel state reports, from the active state to the inactive state in an absence of initiation of the inactivity timer.

2. The UE of claim 1, wherein one or more fields of the low power wake up signal comprise the first control information that triggers the one or more aperiodic channel state reports and the second control information that indicates the UE is to refrain from initiating the inactivity timer.

3. The UE of claim 2, wherein the one or more fields of the low power wake up signal indicate whether to monitor one or more downlink channels during an ON duration after the low power wake up signal.

4. The UE of claim 1, wherein downlink control information comprises the first control information that triggers the one or more aperiodic channel state reports, and wherein one or more fields of the low power wake up signal comprise the second control information that indicates the UE is to refrain from initiating the inactivity timer responsive to receipt of the downlink control information, the first control information received after the second control information.

5. The UE of claim 1, wherein the low power wake up signal indicates to monitor a physical downlink control channel during an ON duration after the low power wake up signal, and wherein the processing system is further configured to cause the UE to:
monitor the physical downlink control channel during the ON duration, wherein receipt of the first control information is based at least in part on the monitoring, and wherein the switch from the active state to the inactive state is after the ON duration.

6. The UE of claim 1, wherein downlink control information comprises the first control information that triggers the one or more aperiodic channel state reports and the second control information that indicates the UE is to refrain from initiating the inactivity timer.

7. The UE of claim 6, wherein the downlink control information indicates whether to monitor one or more downlink channels during an ON duration after the downlink control information.

8. The UE of claim 1, wherein the first control information comprises a request for an aperiodic channel state information report or for an aperiodic channel state feedback report.

9. The UE of claim 8, wherein, to receive the second control information, the processing system is configured to cause the UE to:
receive configuration information associated with the request for the aperiodic channel state information report or for the aperiodic channel state feedback report, the configuration information indicating the UE is to refrain from initiating the inactivity timer responsive to receipt of the request for the aperiodic channel state information report or for the aperiodic channel state feedback report.

10. The UE of claim 1, wherein the first control information indicates one or more event-based criteria associated with triggering the one or more aperiodic channel state reports, and wherein, to transmit the one or more aperiodic channel state reports, the processing system is configured to cause the UE to:
transmit the one or more aperiodic channel state reports based at least in part on satisfaction of the one or more event-based criteria.

11. The UE of claim 10, wherein the one or more event-based criteria are based at least in part on one or more reference signal received power (RSRP) measurements, one or more reference signal received quality (RSRQ) measurements, one or more signal-to-interference noise ratio (SINR) measurements, one or more channel state information reference signal resource indices (CRIs), one or more synchronization signal block resource indices (SSBRIs), or a combination thereof.

12. The UE of claim 1, wherein the processing system is further configured to cause the UE to:
receive, after receipt of the first control information, third control information that schedules one or more uplink or downlink messages and excludes a request for a channel state report; and
initiate the inactivity timer responsive to receipt of the third control information that excludes the request for the channel state report.

13. The UE of claim 1, wherein the low power wake up signal indicates to refrain from monitoring one or more downlink channels and indicates the UE is to transition to the active state until transmission of the one or more aperiodic channel state reports.

14. The UE of claim 1, wherein the low power wake up signal indicates one or more parameters associated with the one or more aperiodic channel state reports, and wherein transmission of the one or more aperiodic channel state reports is in accordance with the one or more parameters.

15. The UE of claim 1, wherein the processing system is further configured to cause the UE to:
receive downlink control information comprising one or more first bits indicating whether to initiate the inactivity timer, one or more second bits indicating a duration of the inactivity timer, or both.

16. The UE of claim 1, wherein the second control information indicates a plurality of trigger states associated with the one or more aperiodic channel state reports and a plurality of inactivity timer behaviors each corresponding to a respective one of the plurality of trigger states, and wherein the first control information that triggers the one or more aperiodic channel state reports indicates one of the plurality of trigger states.

17. A method for wireless communications by a user equipment (UE), comprising:
receiving a low power wake up signal that indicates the UE is to transition from an inactive state to an active state;
receiving first control information that triggers one or more aperiodic channel state reports;
receiving second control information that indicates the UE is to refrain from initiating an inactivity timer;
transmitting, responsive to the first control information, the one or more aperiodic channel state reports while in the active state; and
switching, after transmission of the one or more aperiodic channel state reports, from the active state to the inactive state in an absence of initiation of the inactivity timer.

18. The method of claim 17, wherein one or more fields of the low power wake up signal comprise the first control information that triggers the one or more aperiodic channel state reports and the second control information that indicates the UE is to refrain from initiating the inactivity timer.

19. The method of claim 18, wherein the one or more fields of the low power wake up signal indicate whether to monitor one or more downlink channels during an ON duration after the low power wake up signal.

20. A non-transitory computer-readable medium storing code for wireless communications at a user equipment (UE), the code comprising instructions executable by one or more processors to:
receive a low power wake up signal that indicates the UE is to transition from an inactive state to an active state;
receive first control information that triggers one or more aperiodic channel state reports;
receive second control information that indicates the UE is to refrain from initiating an inactivity timer;
transmit, responsive to the first control information, the one or more aperiodic channel state reports while in the active state; and
switch, after transmission of the one or more aperiodic channel state reports, from the active state to the inactive state in an absence of initiation of the inactivity timer.
